(19) United States
(12) Patent Application Publication
(10) Pub. No.: US 2004/0142057 A1
(43) Pub. Date: Jul. 22, 2004

(54) Pressure-controlling device for an injection mold

(75) Inventors: Po-Sung Kao, Taichung (TW); Shih-Chung Chen, Taichung (TW); Sheng-Jui Chao, Taichung (TW)

Correspondence Address: Ladas & Parry, Suite 2100, 5670 Wilshire Boulevard, Los Angeles, CA, 90036-5679, US

(73) Assignee: ASIA OPTICAL CO., INC.

(21) Appl. No.: 10/752,882

(22) Filed: Jan. 6, 2004

(30) Foreign Application Priority Data
Jan. 20, 2003 (TW) 092101142

(51) Int. Cl. B29C 47/92

(52) U.S. Cl. 425/149; 425/590; 425/150

(57) ABSTRACT

A pressure-controlling device is used in an injection mold that includes a movable component, a stationary component, and a cavity defined by the movable and stationary components. The pressure-controlling device includes a piezoelectric actuator, a pressure sensor, and a control unit. The piezoelectric actuator is connected to the movable component for actuating the movable component. The pressure sensor is connected to the stationary component, and outputs a signal in response to pressure in the cavity. The control unit is connected electrically to the piezoelectric actuator and the pressure sensor, processes the signal from the pressure sensor, and controls the piezoelectric actuator to move the movable component and to adjust the pressure in the cavity.

### CROSS-REFERENCE TO RELATED APPLICATION

This application claims priority of Taiwanese application No. 092101142, filed on Jan. 20, 2003.

### BACKGROUND OF THE INVENTION

1. Field of the Invention

The invention relates to a pressure-controlling device, more particularly to a piezoelectric pressure-controlling device for an injection mold.

2. Description of the Related Art

FIG. 1 illustrates a plot of pressure in a mold cavity versus molding time during a molding process. The resulting curve is generally divided into three stages, i.e., an injecting stage (I), a compressing stage (II), and a pressure-maintaining and molding stage (III). In the pressure-maintaining and molding stage, material inside the mold cavity is cured and molded to form a molded article. Therefore, the pressure in the mold cavity is decreased gradually.

The quality of the molded article primarily depends on the pressure variation in the mold cavity during the molding process. Therefore, a pressure sensor is normally used for monitoring the pressure variation in the mold cavity during the molding process. Different pressure variation curves for different molded articles are analyzed to determine the pressure variation curve for the molded article with optimum quality, which can be used as reference pressure data for producing a molded article with superior quality.

FIG. 2 shows a semi-finished product of an optical lens 1, which is produced by a conventional single-step molding process. In the single-step molding process, the semi-finished product of the optical lens 1 is produced by molding a material in a cavity of constant volume. The pressure variation in the cavity during the pressure-maintaining and molding stage of the molding process cannot be controlled. Therefore, the quality of the optical lens 1 cannot be controlled accordingly. Furthermore, the cavity is provided with a runner at the side thereof, which may result in an uneven pressure distribution along a transverse direction of the cavity, i.e., the injecting point of the runner has the highest pressure. Therefore, the optical lens 1 produced in the cavity has an uneven density, which will negatively affect the optical properties thereof.

Referring to FIGS. 3, 4, and 5, a conventional two-step molding process is conducted with the use of a mold unit that includes a movable clamp plate 2, a stationary clamp plate 3, a resilient member 4, and cores 5, 6. Referring FIG. 3, a first mold-closing step of the conventional molding process is conducted so that a thickness of a cavity 7 (i.e., a spacing distance between the cores 5, 6) is t+Δt. A constant amount of material is then injected into the cavity 7. Referring to FIG. 4, a second mold-closing step of the molding process is conducted with the aid of the resilient member 4 to obtain a desired thickness (t) of the optical lens 8. Excess molding material resulting from the second mold-closing step is guided into an overflow recess (not shown).

However, the aforesaid two-step molding process has the following shortcomings:

1. Although the thickness of the cavity 7 can be controlled by the resilient member 4, the pressure variation in the cavity 7 during the pressure-maintaining and molding stage of the molding process cannot be controlled.

2. Since the excess molding material is guided from the cavity 7 along the transverse direction into the overflow recess, uneven pressure distribution may result along the transverse direction of the cavity 7. Therefore, the optical lens 8 produced thereby has an uneven density, which will negatively affect the optical properties thereof.

3. Referring to FIG. 5, since the excess material 801 is required to be further processed, material is wasted, and the process is relatively costly and complicated.

### SUMMARY OF THE INVENTION

Therefore, in the first aspect, the present invention provides a pressure-controlling device for an injection mold that includes a movable component, a stationary component, and a cavity defined by the movable and stationary components. The pressure-controlling device includes a piezoelectric actuator, a pressure sensor, and a control unit. The piezoelectric actuator is adapted to be connected to the movable component for actuating the movable component. The pressure sensor is adapted to be connected to the stationary component, and outputs a signal in response to pressure in the cavity. The control unit is connected electrically to the piezoelectric actuator and the pressure sensor, processes the signal from the pressure sensor, and controls the piezoelectric actuator to move the movable component and to adjust the pressure in the cavity.

In the second aspect, the present invention provides a mold assembly for injection molding a material. The mold assembly includes a mold unit, a cavity, and a pressure-controlling device. The mold unit includes a stationary component, and a movable component movable toward and away from the stationary component. The cavity is defined by the movable and stationary components. The pressure-controlling device includes a piezoelectric actuator and a pressure sensor. The piezoelectric actuator is connected to the movable component for actuating the movable component. The pressure sensor is connected to the stationary component, senses pressure in the cavity, and outputs a signal corresponding to the pressure.

In the third aspect, the present invention provides an injection molding machine including a support base, a clamping unit, a mold unit, a driving unit, and an injection unit. The clamping unit is mounted on the support base, and has a stationary platen and a movable platen opposite to the stationary platen. The mold unit is mounted between the stationary platen and the movable platen on the support base, and includes a stationary mold part, a movable mold part, a stationary core, a movable core, a cavity, and a pressure-controlling device. The stationary mold part is mounted on the stationary platen. The movable mold part is mounted on the movable platen and is movable toward and away from the stationary mold part. The stationary core is mounted in one of the stationary and movable mold parts. The movable core is mounted in the other one of the movable and stationary mold parts, and is movable toward and away from the stationary core. The cavity is defined by the movable and stationary cores. The pressure-controlling device includes a piezoelectric actuator, a pressure sensor, and a control unit. The piezoelectric actuator is connected to the movable core so as to actuate the movable core. The pressure sensor is connected to the stationary core, senses pressure in the cavity, and outputs a signal corresponding to the pressure. The control unit is connected electrically to the piezoelectric actuator and the pressure sensor, processes the signal from the pressure sensor, and controls the piezoelectric actuator to move the movable core and to adjust the pressure in the cavity. The driving unit is mounted on the support base, and is operable so as to drive the movable platen to move the movable mold part toward and away from the stationary mold part. The injection unit is mounted on the support base for injecting a molding material into the cavity of the mold unit.

### BRIEF DESCRIPTION OF THE DRAWINGS

Other features and advantages of the present invention will become apparent in the following detailed description of the preferred embodiments with reference to the accompanying drawings, of which:

FIG. 1 is a plot showing the relationship of cavity pressure versus molding time;

FIG. 2 is a schematic sectional view of a semi-finished product of an optical lens;

FIG. 3 is a sectional view of a conventional mold unit to illustrate a first mold-closing step of a conventional two-step molding process;

FIG. 4 is a sectional view of the mold unit to illustrate a second mold-closing step of the conventional two-step molding process;

FIG. 5 is a schematic sectional view of a semi-finished product of an optical lens produced by the conventional two-step molding process;

FIG. 6 is a schematic view of an injection molding machine that incorporates the first preferred embodiment of the pressure-controlling device according to this invention;

FIG. 7 is a block diagram of the first preferred embodiment;

FIG. 8 is a sectional view of the first preferred embodiment;

FIG. 9 is a fragmentary enlarged view of FIG. 8;

FIGS. 10 and 11 illustrate how an optical lens is made using the first preferred embodiment;

FIG. 12 is a sectional view of a mold unit that incorporates the second preferred embodiment of the pressure-controlling device according to this invention; and

FIG. 13 is a sectional view of a mold unit that incorporates the third preferred embodiment of the pressure-controlling device according to this invention.

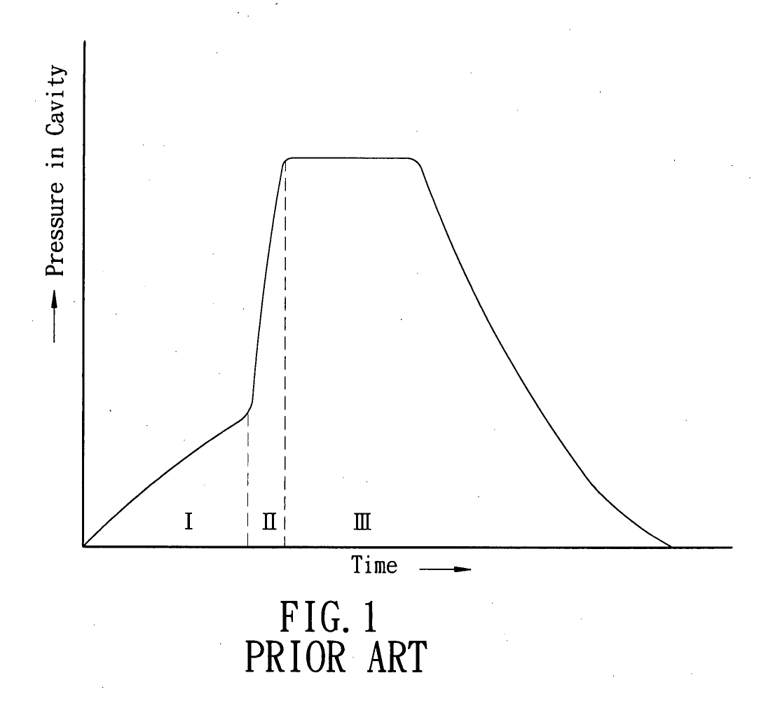

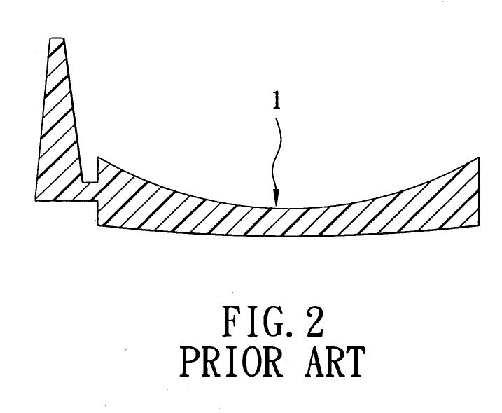

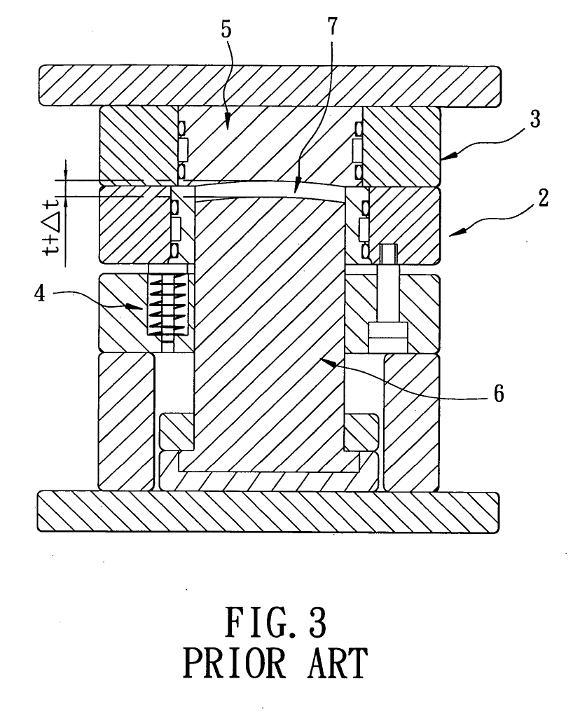

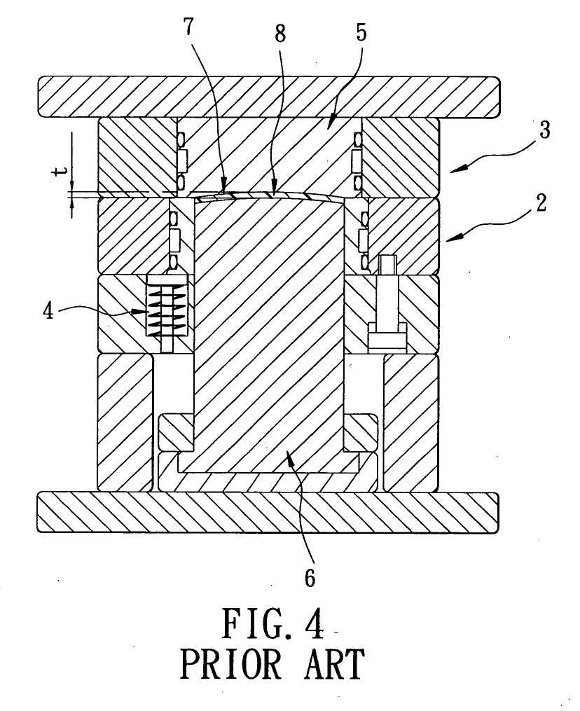

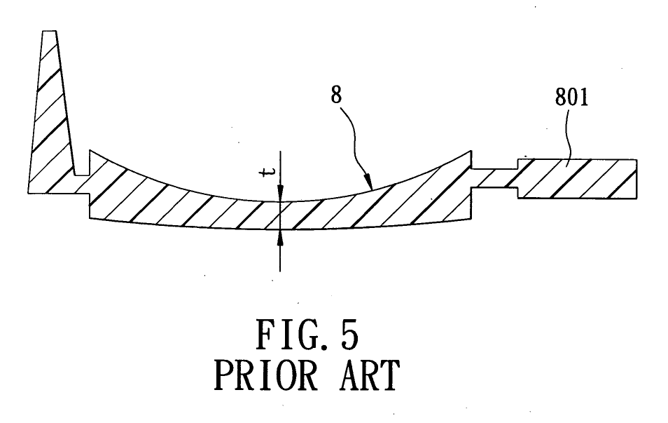

### DETAILED DESCRIPTION OF THE PREFERRED EMBODIMENTS

Before the present invention is described in greater detail, it should be noted that like elements are denoted by the same reference numerals throughout the disclosure.

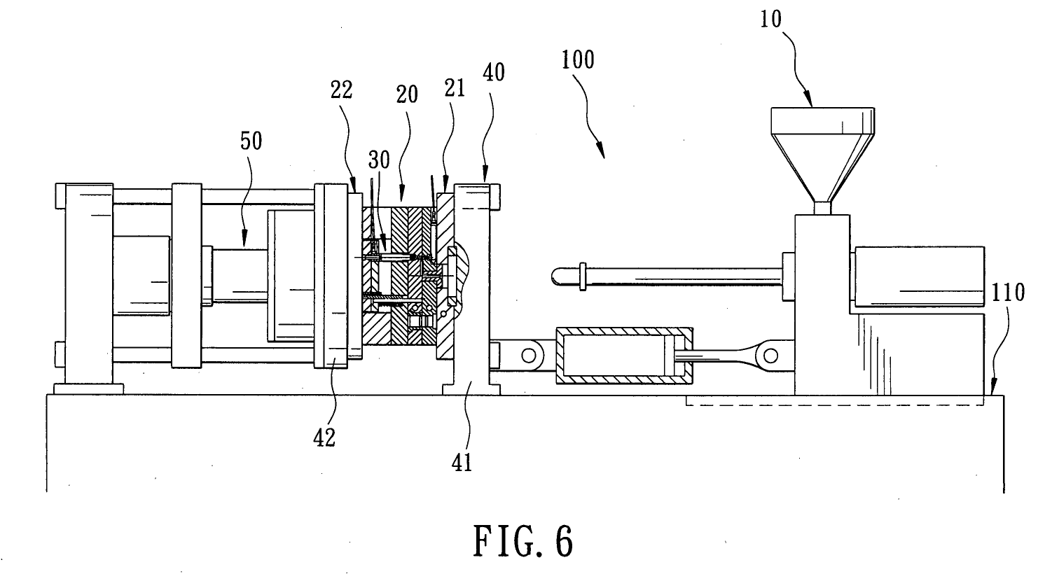

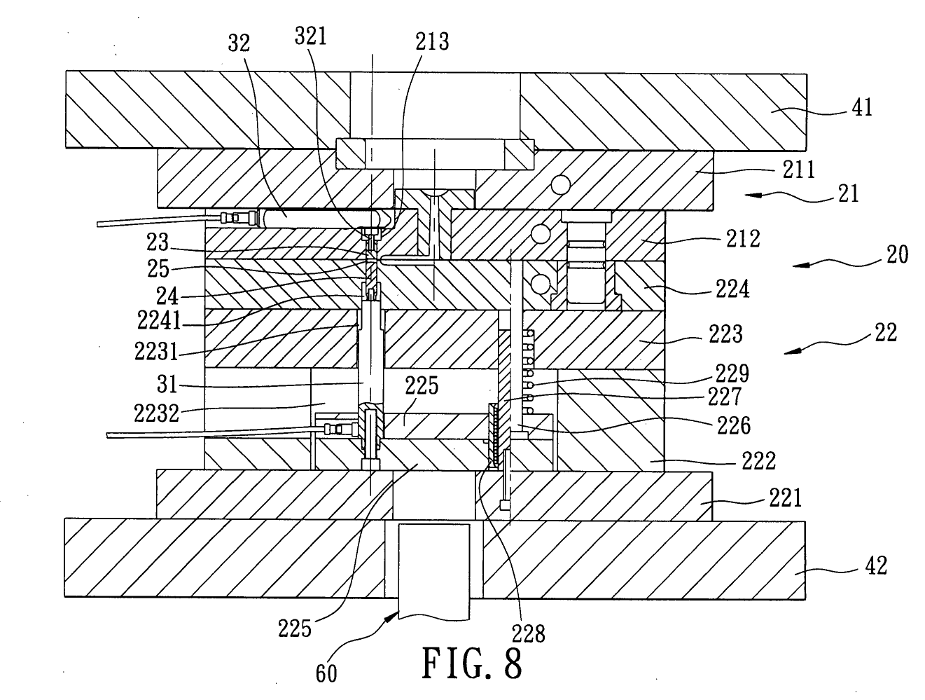

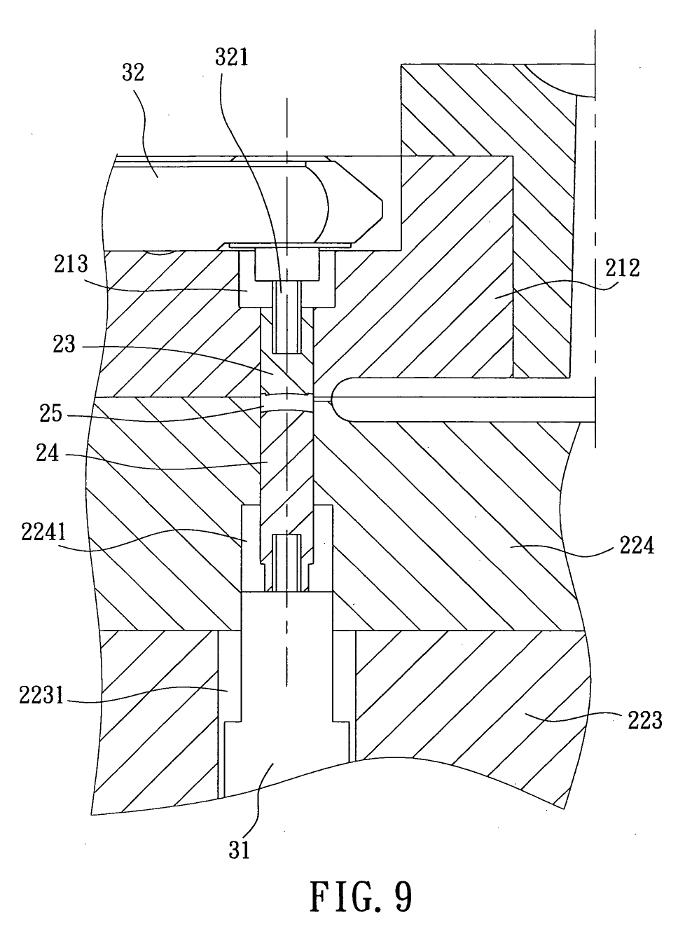

Referring to FIGS. 6, 7, 8, and 9, the first preferred embodiment of the pressure-controlling device 30 according to this invention is shown to be used in an injection molding machine 100 for injection molding a material into a molded article. In the preferred embodiment, the material for injection molding is a plastic material, and the molded article is an optical lens. The injection molding machine 100 includes a support base 110, a clamping unit 40, a mold unit 20, a driving unit 50, and an injection unit 10.

The clamping unit 40 is mounted on the support base 110, and has a stationary platen 41 and a movable platen 42 opposite to the stationary platen 41.

The mold unit 20 is mounted between the stationary platen 41 and the movable platen 42 on the support base 110, and includes a stationary mold part 21, a movable mold part 22, a stationary core 23, a movable core 24, a cavity 25, and the pressure-controlling device 30. In this embodiment, the stationary mold part 21 is mounted on the stationary platen 41. The movable mold part 22 is mounted on the movable platen 42, and is movable toward and away from the stationary mold part 21. The stationary core 23 is mounted in the stationary mold part 21. The movable core 24 is mounted in the movable mold part 22, and is movable toward and away from the stationary core 23. The cavity 25 is defined by the movable and stationary cores 24, 23.

The pressure-controlling device 30 includes a piezoelectric actuator 31, a pressure sensor 32, and a control unit 33. The piezoelectric actuator 31 is connected to the movable core 24 so as to actuate the movable core 24 by a converse piezoelectric effect. For example, when the piezoelectric actuator 31 is supplied with a positive voltage, the piezoelectric actuator 31 actuates the movable core 24 to move toward the stationary core 23 so as to increase the pressure in the cavity 25. On the other hand, when the piezoelectric actuator 31 is supplied with a negative voltage, the piezoelectric actuator 31 actuates the movable core 24 to move away from the stationary core 23 so as to decrease the pressure in the cavity 25. Preferably, the piezoelectric actuator 31 moves the movable core 24 by a dimension order which is smaller than a tolerance of thickness of the molded article to be formed in the cavity 25. In the preferred embodiment, the piezoelectric actuator 31 is a product available from Physik Instrumente Co.

The pressure sensor 32 is connected to the stationary core 23 through a bolt 321, senses pressure in the cavity 25, such as by a direct piezoelectric effect, and outputs a signal corresponding to the pressure. In the preferred embodiment, the pressure sensor 32 is a product available from KISTLER Co.

The control unit 33 is connected electrically to the piezoelectric actuator 31 and the pressure sensor 32, processes the signal from the pressure sensor 32, and controls the piezoelectric actuator 31 to move the movable core 24 and to adjust the pressure in the cavity 25. The control unit 33 includes a central processing unit 333 that stores reference pressure data therein. The central processing unit 333 receives and compares the signal from the pressure sensor 32 with the reference pressure data, and produces an output signal to actuate the piezoelectric actuator 31 so as to move the movable core 24 and to adjust the pressure in the cavity 25. The control unit 33 further includes an amplifier 331 for receiving and amplifying the signal from the pressure sensor 32, and for outputting an amplified signal; and an analog-to-digital converter 332 for converting the amplified signal into a digital signal that is provided to the central processing unit 333.

The driving unit 50 is mounted on the support base 110, and is operable so as to drive the movable platen 42 to move the movable mold part 22 toward and away from the stationary mold part 21. The injection unit 10 is mounted on the support base 110 for injecting a molding material into the cavity 25 of the mold unit 20.

In this embodiment, the stationary mold part 21 includes a stationary mounting plate 211, and a stationary retainer plate 212 mounted on and adjoining to stationary mounting plate 211. The stationary retainer plate 212 has a receiving cavity 213 for receiving the stationary core 23 and the pressure sensor 32 therein. The movable mold part 22 includes a movable mounting plate 221, a spacer block 222, a support plate 223, a movable retainer plate 224, an ejector plate 225, an ejector pin 226, an axle 227, a sliding bearing 228, and a return spring 229. The spacer block 222 is mounted on and adjoining to the movable mounting plate 221. The support plate.223 is mounted on and adjoining to the spacer block 222 and is disposed opposite to the movable mounting plate 221. The support plate 223 has a first hole 2231, and is spaced apart from the movable mounting plate 221 by the spacer block 222 to define an ejecting space 2232. The movable retainer plate 224 is mounted on and adjoins to the support plate 223, is disposed opposite to the spacer block 222, and has a second hole 2241 in communication with the first hole 2231. The ejector plate 225 is mounted within the ejecting space 2232.

The injection molding machine 100 is further provided with an ejector rod 60 for moving the ejector plate 225 toward the stationary retainer plate 212. The return spring 229 is used to bias the ejector plate 225 away from the stationary retainer plate 212. The piezoelectric actuator 31 and the movable core 24 are mounted within the first and second holes 2231, 2241. The piezoelectric actuator 31 extends toward and is connected to the ejector plate 225.

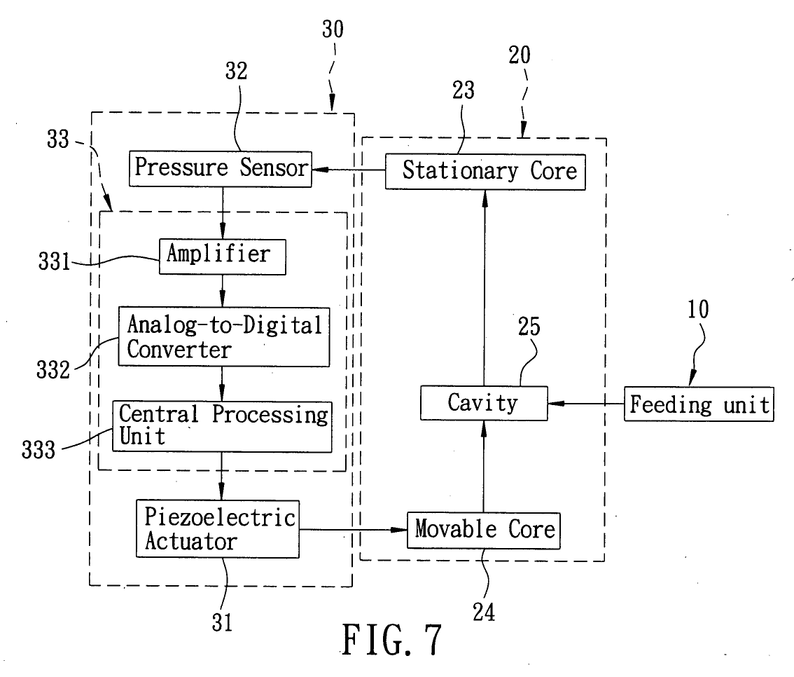

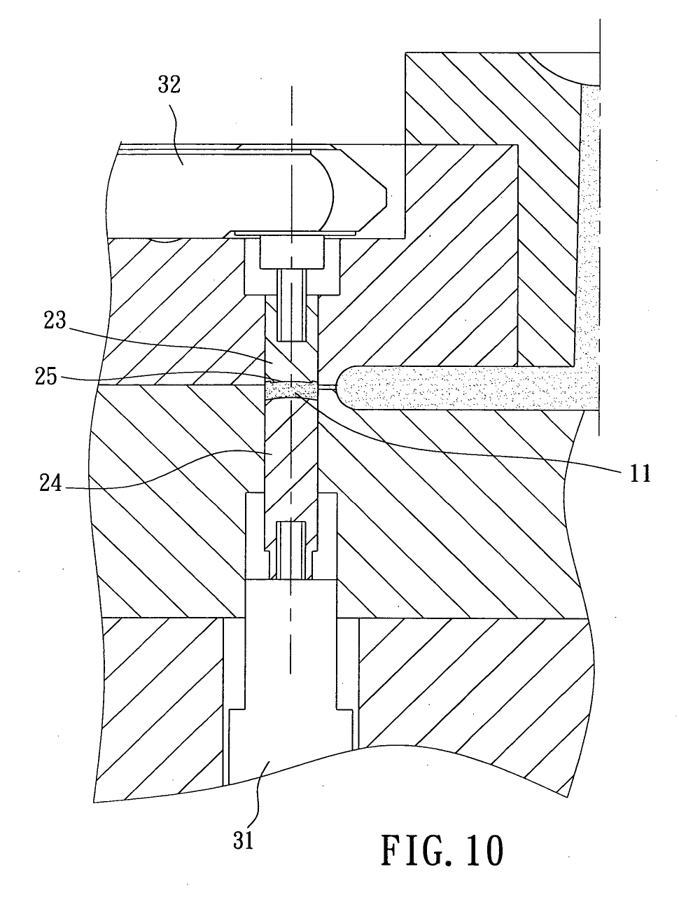

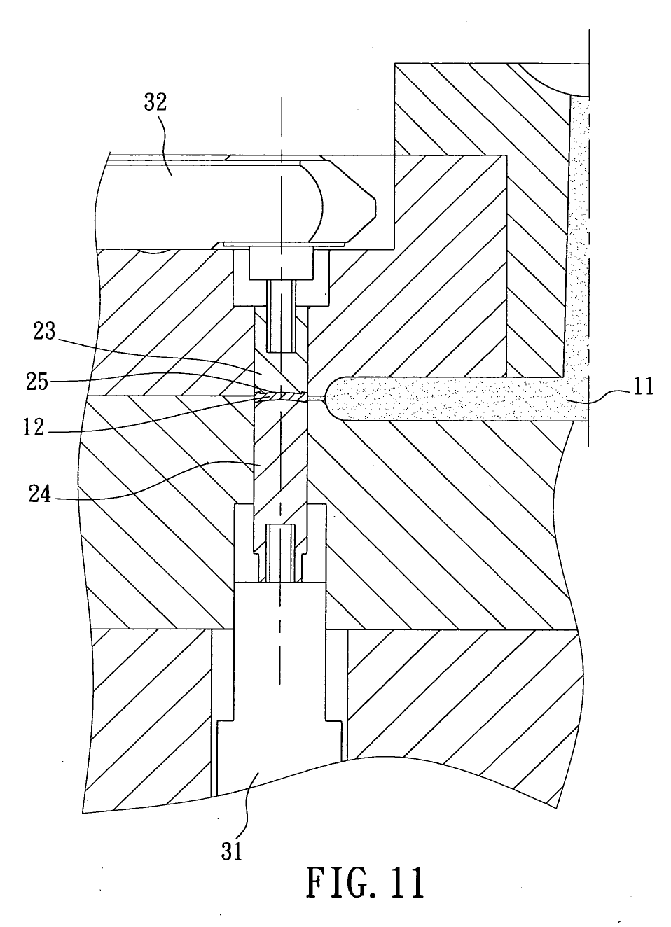

Referring to FIGS. 7, 10 and 11, during the injection molding for manufacturing the molded article 12, the piezoelectric actuator 31 is initially actuated to move the movable core 24 away from the stationary core 23 so as to expand the cavity 25. A certain amount of material 11 is then fed into the cavity 25. The piezoelectric actuator 31 is subsequently actuated to move the movable core 24 toward the stationary core 23. The pressure-controlling device 30 adjusts the pressure in the cavity 25 so as to match the pressure with the reference pressure data as closely as possible during the injection molding. Particularly, the central processing unit 333 of the control unit 33 receives and compares the signal corresponding to the pressure in the cavity 25 with the reference pressure data stored therein, and produces an output signal to actuate the piezoelectric actuator 31 for moving the movable core 24 so as to adjust the pressure in the cavity 25 to match the reference pressure data as closely as possible. Therefore, the pressure in the cavity 25 can be controlled during the injection molding, and the quality of the molded article 12 can be enhanced accordingly.

In view of the aforesaid, the followings are some of the advantages of the present invention over the prior art:

1. Since the pressure in the cavity 25 is adjusted by the pressure-controlling device 30 based on reference pressure data during the entire injection molding process, the quality of the molded article produced thereby can be controlled. Furthermore, since the piezoelectric actuator 31 moves the movable core 24 by a dimension order (10⁻⁹ m) which is smaller than a tolerance (10⁻⁵ m) of thickness of the molded article 12 formed in the cavity 25, the accuracy of the size of the molded article 12 will not be affected by the adjustment of the pressure in the cavity 25.

2. A certain amount of material 11 is fed into the cavity 25 before the movable core 24 is actuated by the piezoelectric actuator 31 to move toward the stationary core 23. The prior art problem of uneven pressure distribution along the transverse direction of the cavity, which results from compressing the material in the cavity by the injection unit, can be avoided. Therefore, the molded article 12 manufactured by this invention has an even density, which contributes to good optical properties.

3. Since the overflowing problem of the prior art is not encountered in the invention, a molded article with good optical properties can be produced in a relatively simple and inexpensive manner by this invention.

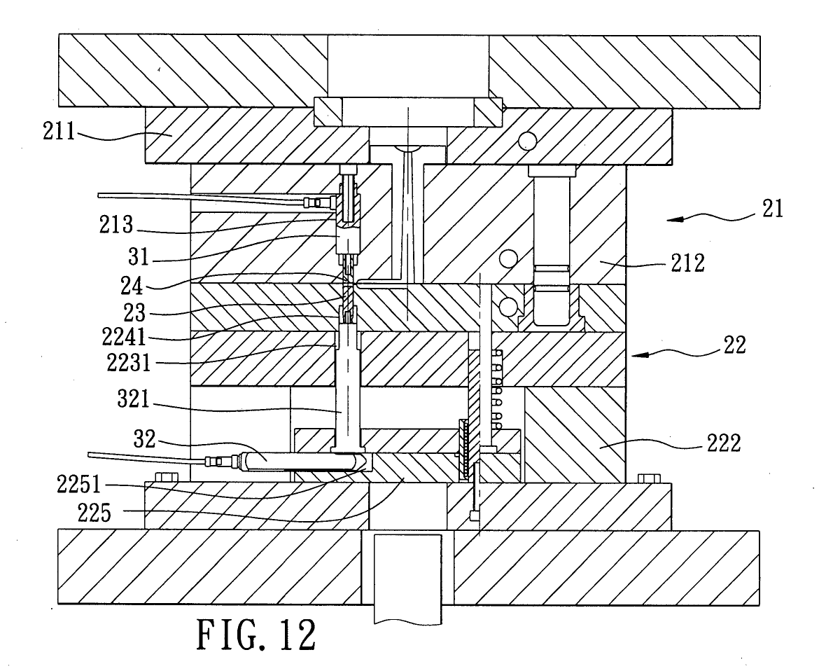

Referring to FIG. 12, the second preferred embodiment of this invention is similar to the first preferred embodiment in structure, except for the following. The movable core 24 is received in the stationary mold part 21, and the stationary core 23 is received in the movable mold part 22. Furthermore, the stationary retainer plate 212 adjoins to the stationary mounting plate 211, and has the receiving cavity 213 for receiving the piezoelectric actuator 31 therein. The movable core 24 is connected to the stationary retainer plate 212 opposite to the stationary mounting plate 211. An elongate coupler 321 interconnects the pressure sensor 32 and the stationary core 23. The coupler 321 and the stationary core 23 are mounted within the first and second holes 2231, 2241, and the coupler 321 extends toward the ejector plate 225. The ejector plate 225 cooperates with the spacer block 222 to define a hole 2251 for receiving the pressure sensor 32 therein.

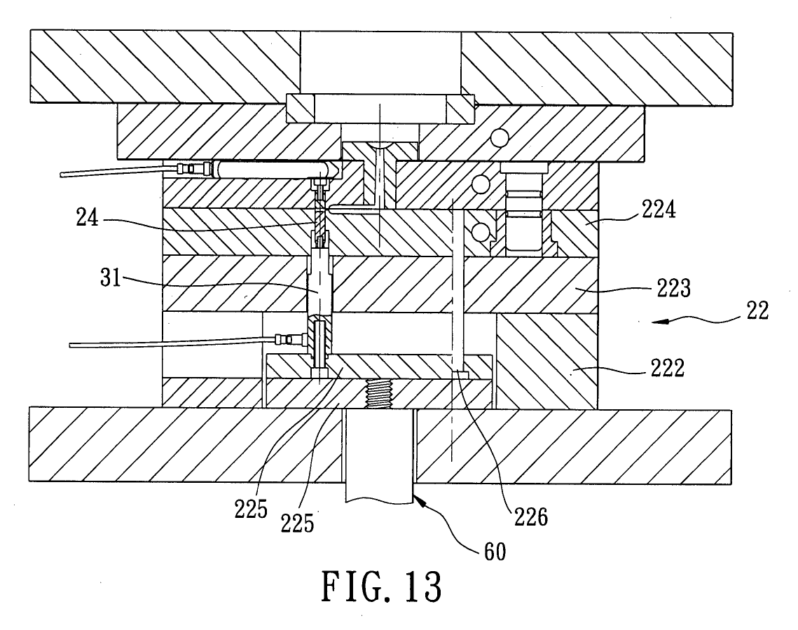

Referring to FIG. 13, the third preferred embodiment of this invention is similar to the first preferred embodiment in structure, except for the following. The movable mold part 22 includes a spacer block 222, a support plate 223, a movable retainer plate 224, two ejector plates 225, and an ejector pin 226. The ejector rod 60 is connected threadedly to one of the ejector plates 225 for moving the ejector plates 225 toward and away from the support plate 223. The piezoelectric actuator 31 is connected between one of the ejector plates 225 and the movable core 24.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A pressure-controlling device for an injection mold, the injection mold including a movable component, a stationary component, and a cavity defined by the movable and stationary components, said pressure-controlling device comprising:
a piezoelectric actuator adapted to be connected to the movable component for actuating the movable component;
a pressure sensor adapted to be connected to the stationary component, said pressure sensor outputting a signal in response to pressure in the cavity; and
a control unit connected electrically to said piezoelectric actuator and said pressure sensor for processing said signal from said pressure sensor and for controlling said piezoelectric actuator to move the movable component and to adjust the pressure in the cavity.

2. The pressure-controlling device as claimed in claim 1, wherein said control unit includes a processing unit that stores reference pressure data therein, said processing unit receiving and comparing said signal from said pressure sensor with said reference pressure data and producing an output signal to actuate said piezoelectric actuator so as to move the movable component.

3. The pressuring-controlling device as claimed in claim 1, wherein said control unit further includes:
an amplifier for receiving and amplifying said signal from said pressure sensor, said amplifier outputting an amplified signal; and
an analog-to-digital converter for converting said amplified signal into a digital signal that is provided to said processing unit.

4. The pressure-controlling device as claimed in claim 1, wherein said piezoelectric actuator is adapted to move the movable component by a dimension order which is smaller than a tolerance of thickness of a molded article to be formed in the cavity.

5. A mold assembly for injection molding a material, comprising:
a mold unit including a stationary component, and a movable component movable toward and away from said stationary component;
a cavity defined by said movable and stationary components; and
a pressure-controlling device including:
a piezoelectric actuator connected to said movable component for actuating said movable component; and
a pressure sensor connected to said stationary component, said pressure sensor sensing pressure in said cavity and outputting a signal corresponding to said pressure.

6. The mold assembly as claimed in claim 5, wherein said pressure-controlling device further includes a control unit connected electrically to said piezoelectric actuator and said pressure sensor for processing said signal from said pressure sensor and for controlling said piezoelectric actuator to move said movable component and to adjust said pressure in said cavity.

7. The mold assembly as claimed in claim 6, wherein said control unit includes a processing unit connected electrically to said piezoelectric actuator and said pressure sensor and storing reference pressure data therein, said processing unit receiving said signal from said pressure sensor, comparing said signal with said reference pressure data, and producing an output signal so as to actuate said piezoelectric actuator to move said movable component and to adjust said pressure in said cavity.

8. The mold assembly as claimed in claim 5, wherein said mold unit further includes a movable mold part and a stationary mold part, said movable component being a movable core received in one of said movable and stationary mold parts, said stationary component being a stationary core received in the other one of said movable and stationary mold parts.

9. The mold assembly as claimed in claim 8, wherein said stationary mold part includes:
a stationary mounting plate; and
a stationary retainer plate mounted on and adjoining to said stationary mounting plate, said stationary retainer plate having a receiving cavity for receiving said stationary core and said pressure sensor therein.

10. The mold assembly as claimed in claim 9, wherein said movable mold part includes:
a movable mounting plate;
a spacer block mounted on and adjoining to said movable mounting plate;
a support plate mounted on and adjoining to said spacer block and disposed opposite to said movable mounting plate, said support plate having a first hole, and being spaced apart from said movable mounting plate by said spacer block to define an ejecting space;
a movable retainer plate mounted on and adjoining to said support plate and disposed opposite to said spacer block, said movable retainer plate having a second hole in communication with said first hole; and
an ejector plate mounted within said ejecting space;
said piezoelectric actuator and said movable core being mounted within said first and second holes, said piezoelectric actuator extending toward and being connected to said ejector plate.

11. The mold assembly as claimed in claim 8, wherein said stationary mold part includes:
a stationary mounting plate; and
a stationary retainer plate mounted on and adjoining to said stationary mounting plate, said stationary retainer plate having a receiving cavity for receiving said movable core and said piezoelectric actuator therein.

12. The mold assembly as claimed in claim 11, wherein said pressure-controlling device further includes an elongate coupler interconnecting said pressure sensor and said stationary core, said movable mold part including:
a movable mounting plate;
a spacer block mounted on and adjoining to said movable mounting plate;
a support plate mounted on and adjoining to said spacer block and disposed opposite to said movable mounting plate, said support plate having a first hole, and being spaced apart from said movable mounting plate by said spacer block to define an ejecting space;
a movable retainer plate mounted on and adjoining to said support plate and disposed opposite to said spacer block, said movable retainer plate having a second hole in communication with said first hole; and
an ejector plate mounted within said ejecting space;
said coupler and said stationary core being mounted within said first and second holes, said coupler extending toward said ejector plate, said pressure sensor being mounted on said ejector plate.

13. The mold assembly as claimed in claim 5, wherein said piezoelectric actuator moves said movable component by a dimension order which is smaller than a tolerance of thickness of a molded article to be formed in said cavity.

14. An injection molding machine, comprising:
a support base;
a clamping unit mounted on said support base, and having a stationary platen and a movable platen opposite to said stationary platen;
a mold unit mounted between said stationary platen and said movable platen on said support base, and including:
a stationary mold part mounted on said stationary platen;
a movable mold part mounted on said movable platen and movable toward and away from said stationary mold part;
a stationary core mounted in one of said stationary and movable mold parts;
a movable core mounted in the other one of said movable and stationary mold parts, and movable toward and away from said stationary core;
a cavity defined by said movable and stationary cores; and
a pressure-controlling device including:
a piezoelectric actuator connected to said movable core so as to actuate said movable core;
a pressure sensor connected to said stationary core, said pressure sensor sensing pressure in said cavity and outputting a signal corresponding to said pressure; and
a control unit connected electrically to said piezoelectric actuator and said pressure sensor for processing said signal from said pressure sensor and for controlling said piezoelectric actuator to move said movable core and to adjust said pressure in said cavity;
a driving unit mounted on said support base, and operable so as to drive said movable platen to move said movable mold part toward and away from said stationary mold part; and
an injection unit mounted on said support base for injecting a molding material into said cavity of said mold unit.
